(19) United States
(12) Patent Application Publication
(10) Pub. No.: US 2008/0046485 A1
(43) Pub. Date: Feb. 21, 2008

(54) Method and System for Disaster Recovery of Servers with Optimized Positioning of Backups on Volumes

(76) Inventor: Kristof De Spiegeleer, Knokke-Heist (BE)

Correspondence Address: DLA PIPER US LLP, 2000 UNIVERSITY AVENUE, E. PALO ALTO, CA, 94303-2248, US

(21) Appl. No.: 11/838,049

(22) Filed: Aug. 13, 2007

Related U.S. Application Data
(60) Provisional application No. 60/822,382, filed on Aug. 15, 2006.

(51) Int. Cl. G06F 17/30

(52) U.S. Cl. 707/204; 707/E17.007

(57) ABSTRACT

The storage system and method stores both primary data and backups of the primary data so that the need for separate storage appliances to store backups is eliminated. In one embodiment, the backup data is located on parts of a disk with lower read and write speed and the parts of the disks with the highest read and write speed are used for primary data.

### PRIORITY CLAIM/RELATED APPLICATIONS

This application claims priority under 35 USC 119(e) and 120 to U.S. Provisional Patent Application Ser. No. 60/822,382 filed on Aug. 15, 2006 and entitled “Method and System for Disaster Recovery of Servers with Optimized Positioning of Backups as Volumes” which is incorporated herein by reference.

### FIELD

The invention is in the field of information technology and in particular storage technology.

### BACKGROUND

Computers and servers use disks (a.k.a. hard disks) as a storage sub system. The speed at which data can be read from disk or written to disk determines, to a significant extent, the overall performance of a computer or server with which the storage sub-system is associated. This is especially true if the amount of data that needs to be read or written is very high.

One specific situation exists when disk-to-disk backups of servers are taken that need to be stored in case a restore is needed. In order to store backups of servers, typically separate servers (storage devices or backup devices) are used that are equipped with a large amount of disks.

Thus, it is desirable to provide a system and method that provides disaster recovery with optimized positioning of backup data.

### BRIEF DESCRIPTION OF THE DRAWINGS

FIG. 1 illustrates a storage system;

FIG. 2 is a schematic representation of the physical layout of a disk including its spindle, platters, arm, read/write head that may be used as the storage device of a storage system shown in FIG. 1;

FIG. 3 is a schematic representation of the logical layout of the disk in FIG. 2 including its tracks and sectors;

FIG. 4 is a schematic representation of a method to determine the size of volumes for primary data and for secondary data and to create said volumes on a disk;

FIG. 5 is a schematic representation of a method to distribute primary data and secondary data on volumes;

FIG. 6 is a schematic representation of a system based on local storage to provide primary storage to physical and virtual servers and secondary storage for backups; and

FIG. 7 is a schematic representation of a system which exposes volumes over the network to provide primary storage to physical and virtual servers and secondary storage for backups.

### DETAILED DESCRIPTION OF ONE OR MORE EMBODIMENTS

The system and method are particularly applicable to a hard disk based storage system and it is in this context that the system and method will be described. It will be appreciated, however, that the system and method has greater utility since it can be used with other types of storage systems and can be implemented using other technologies that would benefit from the system and method.

A method and system to optimize the usage of disks in disk-to-disk backup of servers is provided that eliminates the use of separate storage devices or backup devices. The system and method improve backup and disaster recovery performance, reduce storage cost and reduce bandwidth consumption since bandwidth usage is confined within a well-defined domain. In the case where the domain encompasses the servers located in one rack, bandwidth consumption for storing backups is limited to the rack which results in a significant reduction of inter-rack bandwidth consumption.

A method is also disclosed to optimally store backups of servers in which servers are grouped in one or more domains and each domain is defined as a group of servers which are well interconnected with a sufficiently high speed and low latency network. For example, a domain may be a group of servers located within the same rack in a datacenter, a group of servers connected directly to the same switch, or a group of servers belonging to the same local network. To store a backup within a domain, no bandwidth is used between domains since only bandwidth within the domain is used. In the case where each domain comprises the servers within the same rack, no inter-rack bandwidth is used for backups.

As is typical, backups are taken of so-called one or more primary volumes. Each primary volume is assigned to the servers as primary storage and contain primary data such as operating system files, application files, user files etc. Backups on the other hand (secondary data) are stored on so called secondary volumes. A method is disclosed for the creation of volumes for primary data and for secondary data. The primary volumes and secondary volumes are strategically positioned on certain physical locations of one or more disks. For example, primary data which requires the fastest possible read and write access is written to volumes which are located on physical parts of the disk with the highest throughput rates and lowest latency and secondary data (typically backups of primary data) requires lower read and write speed and is therefore written to volumes on the disk with lower throughput rates and/or higher latency. In the method, the volumes are created in such a way as to allow storage of both primary data and backups on a single disk. In order to improve redundancy, backups of a certain primary volume (a volume used to store primary data), can be stored on a volume of another disk within the same server or on a disk in another server (within the same domain).

A system is also disclosed that implements the above methods. The system acts as a storage sub-system to provide primary storage to physical and virtual servers using primary volumes. The system also takes regular backups of the volumes created on the primary volumes and the backups are stored on secondary volumes. The system keeps a lookup table to map backups stored on secondary volumes to primary volumes. The backups can be block based using snapshot technology or they can be file based. In one preferred embodiment, the system is implemented as a SAN server (fibre channel SAN, IP SAN or any other SAN technology). In a second embodiment, the system uses local disks (a.k.a. direct attached storage or DAS).

The method and system disclosed make use of external backup devices or storage devices for storing backups obsolete, as the available disks, which are currently typically used to store primary data only, are also used to store backups. This reduces cost, increases reliability, and most of all, dramatically reduces the amount of bandwidth used on the local network to store backups. In present situations, backups of servers are typically moved over the local network to storage devices or backup devices. Since backups used for disaster recovery are typically very large in size, this continuous taking of backups and storing of these backups consumes large amounts of bandwidth. By using the method or system disclosed here, the bandwidth consumption is limited to the domain to which both the primary volume and backup volume (on which the backup of the primary volume will be stored) belong. If the domain is limited to one rack with servers, said bandwidth consumption remains within the rack and no inter-rack bandwidth is used to store backups.

The system may also implement a method to determine the optimal physical location of volumes on a disk. The method takes the architecture and intrinsic behavior of the storage devices, such as disks, into account, and combines this knowledge with statistical data and the results of sample tests performed on a disk, in order to create so called primary volumes and secondary volumes. Primary volumes are used to store primary data. Primary data is data used by a live server, e.g. operating system files, application files, user files etc. Secondary volumes are used to store backups of (parts of) primary volumes. Both primary and secondary volumes are created by a volume manager or similar and may be used to host a file system. Primary volumes are created on the primary part of a disk. Secondary volumes are created on the secondary part of the disk. The primary part of the disk (used to store primary data) is the part of the disk with the highest read and write speed, the secondary part (used to store backups) is the remaining part with a lower read and write speed. Hence, primary volumes have a higher average read and write speed than secondary volumes. An example of a storage system that uses a disk based storage device is now described.

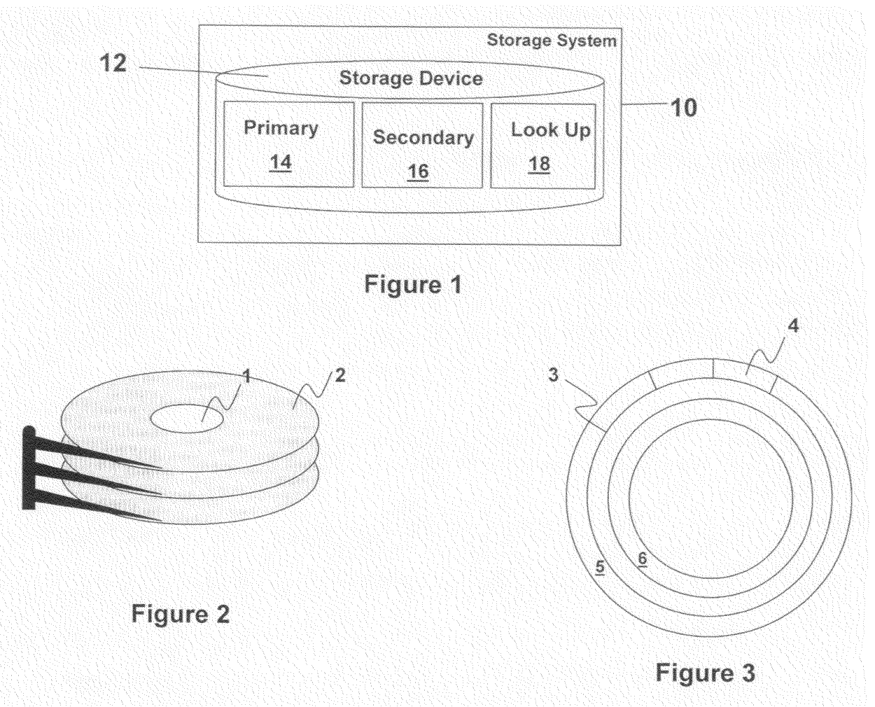

FIG. 1 illustrates a storage system 10 that further comprises a storage device 12 wherein the storage device may be any device that is capable of storing data. In one embodiment, the storage device 12 may be a hard disk drive as shown in FIGS. 1-3 although the system may be implemented with other types of storage devices. In the storage system, the storage device may store a set of primary data 14 and a set of secondary data 16 wherein the primary data is data used by a live system, such as a server, wherein the primary data may be, for example, operating system files, application files, user files etc and the secondary data may be backups of the primary data and wherein the primary data and secondary data are stored in different portions of the storage device as described in more detail below. The storage system 10 may be a storage server computer and may also be a storage attached network (SAN) server.

FIG. 2 is a schematic representation of the physical layout of a disk including its spindle 1, one or more platters 2, arm, read/write head that may be used as the storage device of a storage system shown in FIG. 1. The disk has certain characteristics that determine the maximum speed at which data can be read from or written to certain parts of the storage device. For a disk-based storage device, characteristics such as the physical dimensions of the disk and the radius of the discs, the number of platters, the speed at which the spindle rotates (expressed in rpm, rotations per minute) all possibly impact the read and write speeds on various parts of the disk. One particular situation exists where the outer tracks of a disk have a higher read and write speed compared to the inner tracks.

FIG. 3 is a schematic representation of the logical layout of the disk in FIG. 2 including its tracks and sectors. As shown in FIG. 3, the surface of one platter of a disk is divided into tracks 3 which are concentric circles. Each track is divided into sections 4 called sectors and a sector is the smallest physical storage unit on the disk. The data size of a sector is always a power of two, for example 512 bytes. Most files require multiple sectors to write the data to the disk. Because the radius of outer tracks 5 is bigger than the radius of inner tracks 6, the outer tracks contain more sectors on modern disks. Thus, the disk can write more bits per rotation on an outer track compared to an inner track. In addition, the disk head will, on average, need to make less movements to write a certain file on outer tracks of a disk compared to writing the same files on inner tracks of the disk so that the read and write speeds are higher on outer tracks compared to inner tracks. Other factors that may influence the read and write speed on certain locations of a disk include latency of head movement, certain buffering algorithms implemented in the disk controller and various other factors.

In addition to the above physical characteristics of the disk, certain read and write speed measurements can be performed on the disk. The measurements may include: sequential read, sequential write, random read, random write, buffered read and buffered write. Each of these measurements can be performed by reading or writing blocks of data with varying sizes. The size of the blocks will typically impact performance. The resulting speed for reading or writing data is expressed in MB/s (megabytes per second).

As is well known, when data is written to disk, the head will write each bit of the data one by one. To write the bits, the head will move to a certain track on the surface of a platter and wait for the appropriate sectors to appear underneath the head as the spindle rotates. As the appropriate sectors appear under the head, the data is read or written.

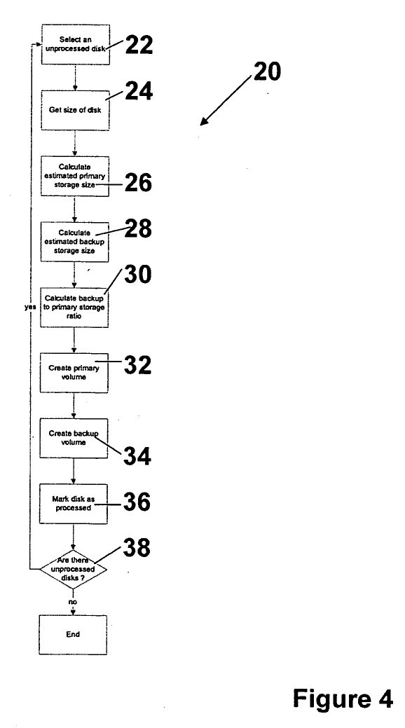

FIG. 4 is a schematic representation of a method 20 to determine the size of volumes for primary data and for secondary data and to create said volumes on a disk. The method may be implemented by a storage system module/tool that has a plurality of lines of computer code that are executed by a processor of the computer system and that implement the method described below. In the method, an unprocessed disk (a disk that has not been divided into a primary volume and a secondary volume) is selected (22) and the total storage area on the disk, expressed in gigabytes for example is determined (24). For example, the disk may be 80 GB. Then, the method calculates an estimate of the space needed for storage of primary data (26) based on the amount of primary data and calculates an estimate of the space needed to store backups (28), based on the estimated size of the primary storage needs, the number of backups taken per day or month and the average size of a backup as a ratio of the primary storage size (e.g. each backup is on average 5% of the size of the primary storage of which the backup is taken). Then, an estimate is made of the backup to primary storage ratio (e.g. for every 100 GB of primary storage 200 GB of backup storage is needed) (30). Then, based on the backup to primary storage ratio, the disk is divided in two parts: a primary part (32) and a secondary part (34). For example for the above ratio (200 GB backup for 100 GB of primary storage), a disk of 60 GB will be divided in a primary part of 20 GB and a secondary part of 40 GB. The physical location on the disk of the primary and secondary part is determined using a method disclosed below in more detail. The primary part is used to create one or more primary volumes and the secondary part is used to create one or more secondary volumes. The disk is then marked as processed (36) and the method determines if there are any remaining unprocessed disks (38) and loops back to process any remaining disks or the method is completed.

The storage system may use various methods to determine the portions of the disk for the primary part and the secondary part. In one embodiment, three methods may be used. A first method to determine the physical location of the primary and secondary part on a disk comprises using the outer tracks as primary part and the inner tracks as secondary part. A second method to determine the physical location of the primary and secondary part on a disk comprises using statistical data of many disk measurements on many similar disks to determine which part of a disk is the primary part and which is the secondary part. A third method to determine the physical location of the primary and secondary part on a disk comprises using sample measurements of the actual disk to determine which part of said disk is primary and which is secondary.

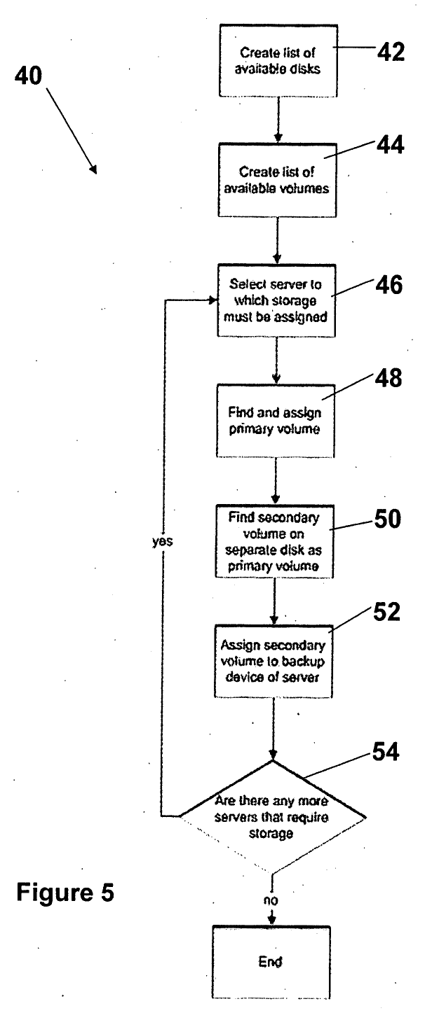

FIG. 5 is a schematic representation of a method 40 to distribute primary data and secondary data on volumes and in particular a method to distribute primary data and secondary data over primary volumes and secondary volumes of one or more disks located in one or more servers within the same domain. The method may be implemented by a storage system module/tool that has a plurality of lines of computer code that are executed by a processor of the computer system and that implement the method described below. In the method, list of all available disks within the domain is created (42) and, for each disk, primary volumes and secondary volumes are created according to the method shown in FIG. 4. Then, a list is created of all available primary volumes and secondary volumes (44).

Next, a system (e.g., a physical or virtual server) to which the storage must be assigned is selected (46). Then, each primary volume is assigned to one physical server or virtual server (48) until the storage requirements for each server requiring storage is satisfied. The relation between volumes and servers is kept in a list. Then, for each primary volume, one available secondary volume is searched in order to store backups of said primary volume (50) wherein the secondary volume is located on a separate storage device. The secondary volume must have the correct size as calculated using the method represented in FIG. 4. The identified secondary volume is “assigned” to said primary storage (52), by keeping a list of assignments. Then, backups of each primary volume will be stored (by the backup service) on the assigned secondary volume according to the assignment list. Then, the method determines if there are any more servers that require storage (54) and then loops back to assign the storage for the servers or the method is completed.

As shown in FIG. 1, the storage system 10 provides primary storage to physical and virtual servers, using primary volumes. The system takes regular backups of the volumes created on the primary volumes and the backups are stored on secondary volumes. The system keeps a lookup table to map backups stored on secondary volumes to volumes on primary volumes. Backups can be block based using snapshot technology or they can be file based. The system uses disks on which volumes are created and the physical location of each volume on one of the disks is determined and each volume is created according to the method represented in FIG. 4. As described above, a volume which is created on a primary part of the disk is called a primary volume and a volume which is created on a secondary part of the disk is called a secondary volume. In the system, a unique identifier is assigned to each volume.

Each primary volume is assigned as a primary volume to a client, according to the method represented by FIG. 5. The primary volumes are used by the clients as primary storage, used by a file system of said client to store OS files, application files, user files etc. A secondary volume is assigned to each primary volume, according to the method represented in FIG. 5. The secondary volume is exposed as a volume to the backup service (part of the system disclosed here) and the secondary volume is used by the backup service to store backups of the primary volume to which it is assigned.

Optionally, the backups of a client and the primary storage of said client are stored on volumes of separate disks in order to reduce the risk of data loss when a disk fails. Optionally primary storage of a server and backups of said server are written to volumes on disks located in separate physical machines to even further reduce the risk of data loss in case of a disaster. Backups are taken by the backup service using a block based snapshot technology or a file based backup technology.

In one embodiment, the system uses the known iSCSI protocol to expose volumes to clients and to the backup service over the network. The backup service takes block based or file based backups of the primary volumes and stores backups on the secondary volumes. In a second embodiment, the system uses any other network protocol to expose volumes over the network to clients and to the backup service wherein the network protocol may be block based or file based.

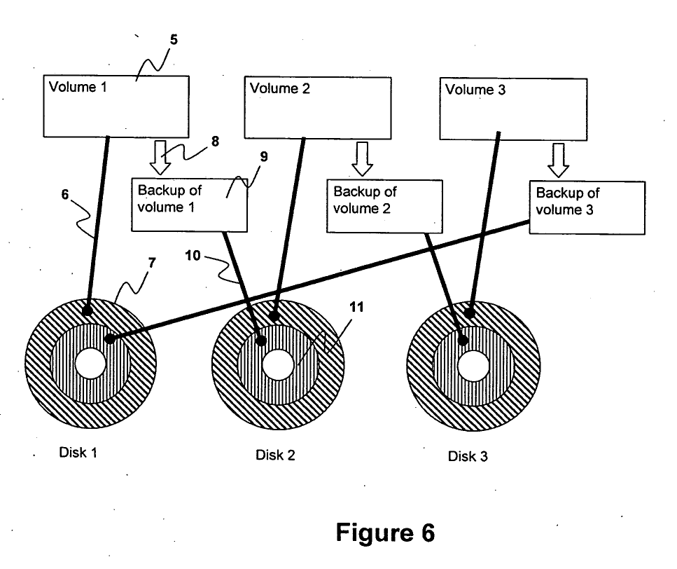

FIG. 6 is a schematic representation of a system based on local storage to provide primary storage to physical and virtual servers and secondary storage for backups. In this embodiment, the storage system uses local disks (a.k.a. DAS or direct attached storage) as shown in FIG. 6 that shows the one or more disks (Disk 1, Disk 2 and Disk 3). The one or more primary volumes (Volume 1, Volume 2 and Volume 3 for example) and secondary volumes (Backup of Volume 1, Backup of Volume 2 and Backup of Volume 3 for example) are created on the local disks according to the method described above. In this embodiment, each primary volume is used to store primary data, the backups are taken locally using a block based snapshot technology or a file based backup technology and the backups are stored on secondary volumes.

As shown in FIG. 6, a primary volume 5 is located on a primary part 7 of a local disk where the primary part in this example is the outer tracks of the disk. The backup 9 of the primary volume 5 are stored on a secondary part 11 of another local disk wherein the secondary part 11 in this example comprises the inner tracks of the disk.

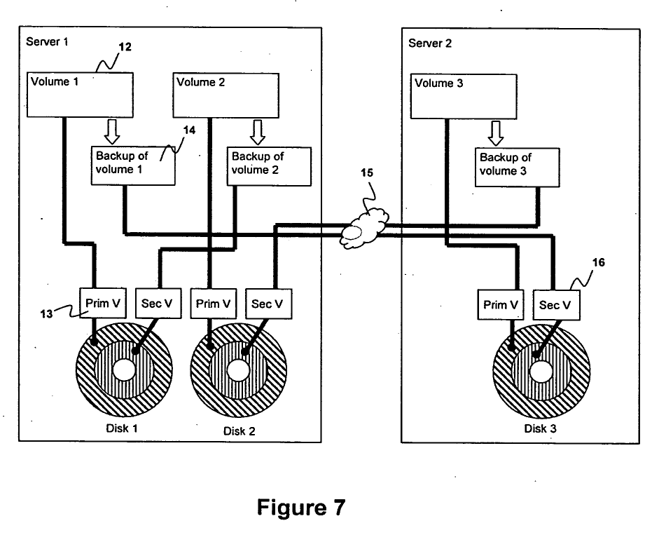

FIG. 7 is a schematic representation of a system which exposes volumes over a network 15 to provide primary storage to physical and virtual servers and secondary storage for backups. In this embodiment, the system uses both volumes on local disks and volumes exposed over the network using the iSCSI protocol (or any other protocol to expose volumes over the network) as depicted in FIG. 7 wherein the network protocol may be block based or file based. As shown in FIG. 7, a primary volume 12 is stored on a primary part 13 of a local disk. The backups 14 of the primary volume are stored on a secondary volume 16 on a disk which is exposed over the network 15.

The system and method reduces the risk of data loss as compared to typical backup setups. In particular, when a disk failure causes loss of primary storage of one server, the backup which is located on another disk is still available for restore. The risk for data loss can further be reduced by distributing the primary and secondary storage of a server over disks in separate physical machines. If a disaster causes the loss of the whole machine containing the disks and hence loss of the primary storage, the backups can still be restored since they are held by a disk in a separate machine. Furthermore, the overall risk of losing all backups is reduced as backups are distributed over all available disks, instead of being stored all in one place.

The system and method also optimizes the utilization of disks since spare space on the disks is used to store backups. In addition, the overall cost of a server infrastructure is therefore reduced as less disks need to be deployed.

As with typical systems, the backups are written during off peak hours (when the usage of primary data is low) so that the reading and writing of secondary data (backups) does not interfere with the reading and writing of primary data. Hence, there is no substantial performance impact for using the same disk for the storage of both primary and secondary data.

The system and method also makes the use of external backup devices and storage devices for storing backups obsolete, as the available disks, which are currently typically used to store primary data only, are also used to store backups. This reduces cost, increases reliability, and most of all, dramatically reduces the amount of bandwidth used on the local network to store backups.

While the foregoing has been with reference to a particular embodiment of the invention, it will be appreciated by those skilled in the art that changes in this embodiment may be made without departing from the principles and spirit of the invention, the scope of which is defined by the appended claims.

1. A storage system, comprising:
a storage device that is capable of storing data;
a primary part of the storage device being used to store a piece of primary data; and
a second part of the storage device being used to store a piece of secondary data wherein the piece of secondary data is a piece of backup primary data.

2. The system of claim 1, wherein the storage device further comprises a disk.

3. The system of claim 2, wherein the primary part of the disk has a higher throughput and lower latency than the second part of the disk.

4. The system of claim 2, wherein the primary part of the disk further comprises a set of outer tracks of the disk and wherein the second part of the disk further comprises a set of inner tracks of the disk.

5. The system of claim 1, wherein the storage device further comprises a lookup part of the storage device that stores a table that maps a piece of primary data to a piece of secondary data associated with the piece of primary data.

6. The system of claim 1, wherein the piece of secondary data further comprises a piece of block based backup data.

7. The system of claim 1, wherein the piece of secondary data further comprises a piece of file based backup data.

8. The system of claim 1 further comprising a plurality of storage devices wherein one or more of the storage devices are located in a domain and wherein the piece of primary data and the piece of secondary data for the one or more storage devices in the domain are stored in the one or more storage devices located in the domain.

9. The system of claim 8, wherein the domain further comprises a rack in a datacenter, a group of storage devices capable of connecting to a switch, or a group of storage devices associated with a local network.

10. A method for storing data, comprising:
determining a size of a storage device;
assigning a primary volume on the storage device, the primary volume being used to store a piece of primary data; and
assigning a second volume on the storage device, the second volume being used to store a piece of secondary data wherein the piece of secondary data is a piece of backup primary data.

11. The method of claim 10, wherein the storage device further comprises a disk.

12. The method of claim 11, wherein assigning the primary volume further comprises assigning the primary volume to a part of the disk with a higher throughput and lower latency than a second part of the disk.

13. The method of claim 11, wherein assigning the primary volume further comprises assigning a set of outer tracks of the disk to the primary volume and wherein assigning the second volume further comprises assigning a set of inner tracks of the disk to the second volume.

14. The method of claim 10 further comprising generating a lookup table that maps a piece of primary data to a piece of secondary data associated with the piece of primary data.

15. The method of claim 10 further comprising generating a piece of block based backup data wherein the block based backup data is the secondary data.

16. The method of claim 10 further comprising generating a piece of file based backup data wherein the filed based backup data is the secondary data.

17. The method of claim 10, wherein assigning the primary volume further comprises assigning a set of tracks of the disk to the primary volume based on statistics of the disk performance.

18. The method of claim 10, wherein assigning the primary volume further comprises assigning a set of tracks of the disk to the primary volume based on a set of measured performance of the disk.
